(19) United States
(12) Patent Application Publication
(10) Pub. No.: US 2003/0150159 A1
(43) Pub. Date: Aug. 14, 2003

(54) Ornamental cover for a potted plant

(76) Inventor: Laura A. Kennedy, Virginia Beach, VA (US)

Correspondence Address: BRADLEY D. GOLDIZEN, 505 S. INDEPENDENCE BLVD., SUITE 102, VIRGINIA BEACH, VA, 23452, US

(21) Appl. No.: 10/074,425

(22) Filed: Feb. 13, 2002

(51) Int. Cl. A01G 9/02

(52) U.S. Cl. 47/72

(57) ABSTRACT

The present invention is an ornamental covering formed from a cylindrically shaped piece of cloth. The ornamental covering includes an elasticized portion affixed at an open end of the cylindrically shaped piece of cloth. A circularly shaped piece of cloth is attached at an opposite end of the cylindrically shaped piece of cloth to form a bottom. The detachable ornament includes a fastener connected to an ornament.

There are no related applications.

This application was not subject to federal research and development funding.

### FIELD OF THE INVENTION

The present invention relates generally to a reusable ornamental covering for a potted plant. The ornamental covering includes an elasticized portion for biasing an open end or mouth of the covering towards a closed position. The ornamental covering may also include a drip pan and a detachable ornament. The present invention also discloses a method for producing the ornamental covering and detachable ornament.

It is an object of the invention to provide a reusable and durable ornamental covering with a detachable ornament for a pot that holds a plant. The ornamental covering alleviates the need for transplanting or use of gardening tools since the decorative ornamental covering will conceal the original pot that holds the plant. The ornamental covering of the present invention can be laundered when it is dirty and reused. The ornamental covering allows one to quickly, easily and simply change the look of any pot holding a plant. The detachable ornaments are interchangeable from ornamental covering to ornamental covering.

### BRIEF DESCRIPTION OF THE DRAWINGS

FIG. 1 is a perspective view of a flowerpot and a potted plant.

FIG. 2 is a perspective view of the ornamental covering.

FIG. 3 is a cross-sectional view of the ornamental covering with a flowerpot, drip pan and a potted plant.

FIG. 4 is a perspective view of a detachable ornament.

FIG. 5 is a perspective view of a detachable ornament as it applies and relates to the ornamental covering.

FIG. 6 is a cross-sectional view of the detachable ornament with the ornamental covering, a flower pot, drip pan and a potted plant.

### DETAILED DESCRIPTION OF THE INVENTION

The present invention comprises a reusable sock or decorative covering for a pot that holds a potted plant. The decorative covering typically comprises a cloth, plastic or other pliable material that may be washed and reused. The cloth is formed in a cylinder shape having a closed end and an open end opposite the closed end. The open end or mouth includes an elasticized portion or drawstring for biasing it towards a closed position. The detachable ornament typically includes a clip, button, hook or other form or method of attachment connected to an ornament or decoration.

Before installing the cover onto the pot or container, a drip pan may be placed in the bottom of the decorative covering to be in contact with the closed end of the decorative covering, thus holding the cylinder shape and allowing for drainage of the plant. To install the decorative covering, a plant in its container or pot is lifted and the mouth of the covering is expanded to a size large enough to accommodate the container or pot. The covering is slid upwards around the rim or lip of the pot. A detachable ornament may then be attached to the ornamental covering.

FIG. 1 shows a pot for holding a potted plant. Pot 31 holds plant 30 therein. The phrase “pot for holding a plant” should be interpreted broadly to include, but not limited to, any type of container for holding a floral grouping or plant. Some examples of pots for holding plants are nursery containers, clay pots, wooden pots, plastic pots and pots made from natural or synthetic materials. Further, it should be noted that the term “plant” should be interpreted broadly to include floral arrangements, artificial flowers, shrubbery, plants and foliage. Pot 31 typically includes a rim, brim or lip 33.

FIG. 2 is a perspective view of the ornamental cover. An ornamental cover 1 typically includes a bottom 3 sewn to side 13 by stitches 11. Folding opposite sides of a rectangular or square piece of cloth together and stitching them to one another forms side 13. Stitches 9 hold the cloth together to form a piece of cloth having a cylindrical shape. An open end or mouth 5 is configured opposite bottom 3. The mouth 5 includes an elastic portion 7 that tends to bias the mouth towards a closed position.

The terms “elastic portion or elasticized portion” as used herein means any material such as elastic bands, Spandex® or rubber bands. It also includes any other type of material such as cord, string, metal, rubber or plastic which may be secured to the mouth of the ornamental covering to bias the mouth towards a closed position. Placing elastic around the upper edge of the cover and folding the cover down to enclose the elastic may form the elasticized portion. Stitching may then be added to permanently affix the elastic to the cover. Otherwise, the elastic may be placed on the interior surface near the top of the cover and the cover may be folded down to enclose the elastic. Stitching may be added to permanently affix the elastic.

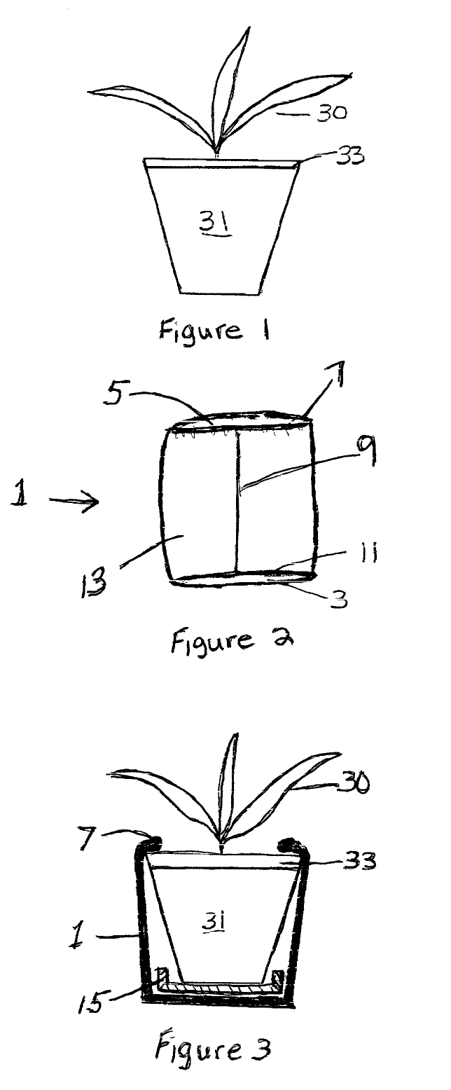

FIG. 3 depicts a cross-sectional view of the ornamental covering as shown installed on the pot for holding a plant. The bottom end of pot 31 is placed into a drip pan 15. The elasticized portion 7 is positioned above brim, lip or rim 33 to secure the ornamental covering 1 in place.

FIG. 4 is a perspective view of the detachable ornament 6 which typically includes a fastener 2 and an ornament 8. The phrase “fastener” should be interpreted broadly to include but not limited to a clip, button, hook or other form or method of attachment. The fastener 2 is affixed to an ornament 8. The phrase “ornament” should also be interpreted broadly to include but not limited to bobbles, balls, tassels, cords, beads, bows, or any other form of decoration or ornamentation.

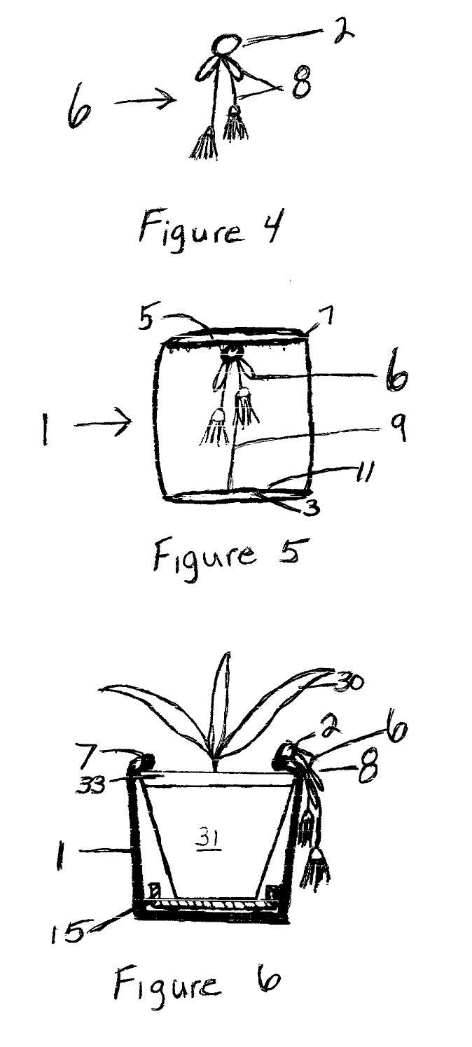

FIG. 5 is a perspective view of the invention. A detachable ornament 6 connects to the ornamental covering 1 as it applies and relates to the ornamental covering 1.

FIG. 6 is a cross-sectional view of the ornamental covering as shown installed on the pot for holding a plant. The bottom end of pot 31 is placed into a drip pan 15. The elasticized portion 7 is positioned above the rim, brim or lip 33 to secure the ornamental covering 1 in place. The detachable ornament 6 is attached and secured in place by the fastener 2 to the elasticized portion 7 at the top.

Changes may be made in the construction and the operation of various components, elements and assemblies described herein or in the steps or processes described herein without deviating or departing from the spirit and scope of the invention.

I claim:

1. A decorative covering for a pot comprising:
a piece of cloth formed in the shape of a cylinder and having two ends;
a circularly shaped piece of cloth affixed to an end of said piece of cloth; and
an elasticized portion affixed to an end of said piece of cloth opposite the circularly shaped piece of cloth.

2. The decorative covering for a pot of claim 1 further comprising a stitched seam running from the circularly shaped piece of cloth to the elasticized portion.

3. The decorative covering for a pot of claim 1 further comprising a stitched seam attaching said circularly shaped piece of cloth to an end of the piece of cloth formed in the shape of a cylinder.

4. The decorative covering for a pot of claim 1 further comprising a drip pan.

5. The decorative covering for a pot of claim 1 further comprising a detachable ornament.

6. An ornamental covering for a pot comprising:
a cylindrically shaped piece of cloth;
a stitched seam running lengthwise from an open end of said cylindrically shaped piece of cloth towards an opposite end thereof;
an elasticized portion attached to said open end of the cylindrically shaped piece of cloth for biasing the open end towards a closed position; and
a circularly shaped piece of cloth stitched to said opposite end of the cylindrically shaped piece of cloth.

7. The ornamental covering for a pot of claim 6, further comprising a detachable ornament.

8. The ornamental covering for a pot of claim 6 further comprising a drip pan.

9. An ornamental covering for a pot comprising:
a cylindrically shaped piece of cloth having a stitched seam;
a circularly shaped piece of cloth stitched to one end of said cylindrically shaped piece of cloth to form a bottom;
an elasticized portion formed at an opposite end;
a drip pan; and
a detachable ornament.
